(19) United States
(12) Patent Application Publication
(10) Pub. No.: US 2005/0108692 A1
(43) Pub. Date: May 19, 2005

(54) System and method of generating applications for mobile devices

(75) Inventors: Allen N.L. Lau, Markham (CA); Oliver Attila Tabay, Toronto (CA); Ivan Yik Fong Yuen, Markham (CA); Martin Anthony Tarle, Toronto (CA)

Correspondence Address: BERESKIN AND PARR, 40 KING STREET WEST, BOX 401, TORONTO, ON, M5H 3Y2, CA

(73) Assignee: Tira Wireless Inc., Toronto (CA)

(21) Appl. No.: 10/975,346

(22) Filed: Oct. 29, 2004

Related U.S. Application Data
(63) Continuation-in-part of application No. 10/782,917, filed on Feb. 23, 2004.
Application No. 10/782,917 is a continuation-in-part of application No. 10/713,024, filed on Nov. 17, 2003.

(51) Int. Cl. G06F 9/45

(52) U.S. Cl. 717/136

(57) ABSTRACT

A method and system of generating target applications from Java reference applications for a particular combination of mobile devices is provided. The method includes the steps of: a) unpacking the reference application into a number of class files; and b) transforming the reference application into the target application by a device plug-in. The device plug-in is capable of transforming different reference applications into corresponding target applications for a particular combination of the reference mobile device and the target mobile device. The system includes a transformation engine and a device plug-in corresponding to the reference/target mobile device combination. The device plug-in includes an XML file and pieces of software code to modify corresponding portions of the reference application not supported by the target mobile device. The XML file directs the transformation engine to identify the unsupported portion of the reference application and to modify the portion with the selected software code.

### CROSS-REFERENCE TO RELATED APPLICATIONS

This application is a continuation-in-part of prior U.S. application Ser. No. 10/782,917, filed on Feb. 23, 2004, which is a continuation-in-part of prior U.S. application Ser. No. 10/713,024, filed on Nov. 17, 2003. The contents of U.S. application Ser. Nos. 10/782,917 and 10/713,024 are incorporated by reference herein.

### FIELD OF THE INVENTION

The invention relates to automated application development. In particular, the invention relates to systems and methods for generating applications for mobile devices from a reference Java application.

### BACKGROUND OF THE INVENTION

The popularity of mobile devices, such as wireless phones, pagers, and personal digital assistants (PDAs) continues to increase. As more and more people acquire mobile devices, the number of different types of devices available have also increased, as well as the capabilities of such devices. Many of these mobile devices are customized using software applications which run on these devices. Examples of application programs available on mobile devices include games, mail programs, and contact management applications.

Application programs are written for a particular computer architecture (and associated instruction set), as well as a particular operating system, which is supported by the architecture. Application programs written for a combination of one particular architecture and operating system may not execute optimally or at all on a different architecture and/or different operating system. This is either due to the fact that the instruction sets and/or the interface to the libraries of the different architectures and operating systems are different and/or due to the fact that there are device constraints/differences such as display size. For this reason, applications that are designed to run on one type of mobile device with a particular architecture operating system combination may not run on another type of mobile device with a different operating system architecture combination. For example, applications which run on Nokia™ devices typically do not run on Motorola™ devices, even when both of these devices support Java.

Several methods to migrate an application from an architecture operating system combination for one mobile device to a different architecture operating system combination for a target mobile device are known.

One such method is the so-called “porting approach”. With the porting approach the software developer takes the source code for the application program to be converted and runs the source code through a compiler developed for the target mobile device.

One disadvantage of porting is that a relatively large amount of time is required to port an application program to the target mobile device. In addition, porting requires significant human intervention, as it is almost certain that the source code has to be modified before it can be compiled and executed properly on the target mobile device. This in turn requires the developer to maintain and manage a different version of the source code for each target mobile device.

Another known method is referred to as the “on-line interpretation” approach. In this method, a software module called an “interpreter” interprets instructions from an executable version of the application program written to run on the first mobile device. The interpreter chooses the appropriate instructions or routines required for the application to execute the same functions in the target mobile device. The interpreter essentially runs as an emulator, which responds to an executable file of the application which runs on the first mobile device, and in turn, creates a converted executable file which runs on the target mobile device.

A disadvantage of the on-line interpretation method is that the interpreter must be able to be loaded and executed on the target mobile device. While this is possible on some systems like desktop personal computer systems, it is not feasible for mobile devices due to size and performance limitations.

Accordingly, there is a need for systems and methods for more quickly and efficiently generating applications for different types of mobile devices from a reference application which runs on one type of mobile device.

### SUMMARY OF THE INVENTION

According to a first aspect of the invention, a method of generating a target application from a reference application is provided. The reference application is a Java application adapted to execute on a reference mobile device and the target application is adapted to execute on a target mobile device. The method comprises: a) unpacking the reference application into a plurality of class files; and b) transforming the reference application into the target application by a device plug-in. The device plug-in is configured to transform different reference applications into corresponding target applications for a particular combination of the reference mobile device and the target mobile device.

Preferably, the device plug-in comprises an instruction file and at least one library, and the transformation step comprises the instruction file instructing a transformation engine to modify a portion of the reference application not supported by the target mobile device with a selected software code stored in the library.

According to a second aspect of the invention, a system for transforming Java reference applications for a reference mobile device into corresponding target applications for a target mobile device is provided. The system comprises a transformation engine and a device plug-in. The device plug-in comprises: i) an instruction file; and ii) a selected software code adapted to modify a portion of the reference application not supported by the target mobile device. The transformation engine is adapted to access the instruction file, which directs the transformation engine to identify the portion of the reference application and to modify the portion with the selected software code.

Preferably, the instruction file is a XML file and the device plug-in comprises a plurality of software codes stored in a library.

The present invention automates the process of migrating applications to target devices which will not otherwise support the reference application, thereby greatly reducing the development time required to migrate the applications, as well as reducing the time and expense required to manage and maintain multiple versions of source code.

### BRIEF DESCRIPTION OF THE DRAWINGS

In the accompanying drawings:

FIG. 1 is a block diagram of a first embodiment of a system of generating applications for mobile devices according to the present invention;

FIG. 2 is a flow diagram showing the operation of the system of FIG. 1;

FIG. 3 is a block diagram of a second embodiment of a system of generating applications for mobile devices according to the present invention; and

FIG. 4 is a flow diagram showing the operation of the system of FIG. 3.

### DETAILED DESCRIPTION OF THE PREFERRED EMBODIMENTS

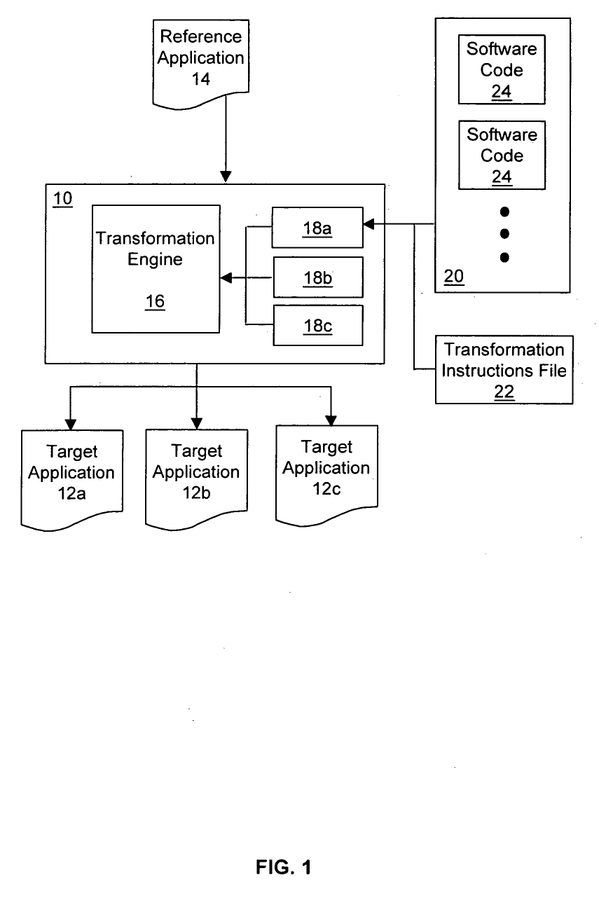

FIG. 1 shows a system 10 for automatically generating any suitable number of target applications from a reference application 14, according to a first embodiment of the present invention. For clarity, three target applications 12a, 12b, and 12c are shown.

The reference application 14 is written to execute on one type of mobile device which supports Java. The mobile device on which the reference application runs will be referred to herein as a reference mobile device (now shown).

The reference application 14 is a Java application which includes any suitable number of class files (not shown). Preferably, the reference application is written for the Java 2 Platform, Micro Edition (J2ME), but could be written on any other Java platform for mobile devices. The reference application 14 is composed of a JAD/JAR (Java Application Descriptor/Java Archive) pair. The mobile device may be any portable computing device, such as a wireless phone, pager, Personal Digital Assistant (PDA), set-top box, or an in-vehicle telematic system.

The J2ME platform is a set of open standard Java Application Program Interfaces (APIs) defined through the Java Community Process program by expert groups that include leading device manufacturers, software vendors and service providers. The J2ME architecture defines configurations, profiles and optional packages as elements for building complete Java runtime environments that meet the requirements for a broad range of devices. Each combination is optimized for the memory, processing power, and input/output capabilities of a related category of devices.

J2ME configuations are composed of a Java Virtual Machine (JVM) and a set of class libraries. They provide the base functionality for a particular range of devices that share similar characteristics, such as memory and processing capability.

Continuing to refer to FIG. 1, the system 10 includes a transformation engine 16. The transformation engine 16 is a software module which runs on a computer, such as, for example, a personal computer having a central processing unit (CPU) and a memory. The transformation engine 16 is preferably a Java application that may be configured to run on a desktop personal computer or a server, although it will be understood that the transformation engine may be written in any suitable language.

The system 10 also includes any suitable numbers of device plug-ins 18 which are preferably stored in the computer memory and which may be accessed by the transformation engine 16. For clarity, three device plug-ins 18a, 18b, 18c are shown in FIG. 1. Each device plug-in 18a, 18b, 18c is capable of transforming applications for a specific combination of a reference mobile device and a target mobile device. As used herein, a “target mobile device” is any mobile device which does not support the reference application 14. Typically, the target mobile device either has a different architecture and/or a different operating system or different device characteristics (e.g. display size, font size, API's etc.) from the reference mobile device. The target mobile device does not “support” the reference application 14 when the reference application 14 does not execute on the target device, or when the reference application is not optimized for execution on the target mobile device. Examples of a lack of optimization may include executing slowly or not rendering graphics correctly on the target mobile device.

For example, the reference device may be a Nokia™ Series 40 wireless telephone, and the target devices may be a Samsung™ S300, a Motorola™ T720, and a Sharp™ GX10 wireless telephone. In this example, device plug-in 18a corresponds to the combination of Nokia™ Series 40 and Samsung™ S300 phones. Device plug-in 18b corresponds to the combination of Nokia™ Series 40 and Motorola™ T720 phones. Device plug-in 18c corresponds to the combination of Nokia™ Series 40 and Sharp™ GX10 phones. p It will be understood by those skilled in the art is that the term “device plug-in” used in this application includes any file or set of instructions which are capable of instructing a computer to transform applications for a specific combination of a reference and target mobile device.

The target applications 12a, 12b, 12c are generated by modifying the reference application 14, as described in detail below. The target applications 12a, 12b, 12c may be Java applications if the target mobile device supports Java. Alternatively, the target applications may be any other type of application supported by a particular target mobile device, such as BREW™ or Symbian™.

Continuing to refer to FIG. 1, each device plug-in 18a, 18b, 18c includes a library 20 and an instruction file 22. For clarity, only the library and instruction file for device plug-in 18a have been shown. However, it will be understood by those skilled in the art that the remaining device plug-ins 18b and 18c also have corresponding libraries and instruction files. The library 20 includes a collection of pieces of software code 24 required to transform the reference application 14 into the target application 12a.

The instruction file 22 is preferably an Extensible Markup Language (XML) file which contains a list of instructions to the transformation engine 16 to generate the target application 12a from the reference application 16.

The library 20 and the instruction file 22 for inserting the software code 24 into the reference application 14 are created in a manner well known in the art, based on a collection of known differences in the characteristics between the reference mobile device and the target mobile device. Typical device characteristics where such differences may be present include without limitation: memory, processing speed, key mapping, screen size, font size, image/sound file format differences, device-specific Java API calls, and non-standard behavior of standard Java API calls.

Specifically, a list of target mobile device APIs may be compared with a list of APIs for the reference mobile device. These lists are available from the device manufacturers and/or mobile telecommunication operators. Each API call on the reference mobile device is mapped to the corresponding API call on the target mobile device. If any API call is not present on the target mobile device, a new method is created to add to the target device class files to provide this functionality. The new method is one example of the software code 24 stored in the library 20.

Some additional detailed examples of the differences present in mobile device characteristics and how they are addressed in the device plug-ins 18a, 18b, 18c are described below in connection with the operation of the present invention.

After each software code 24 in the library 20 is written to address a particular difference in a device characteristic (such as those shown in the examples below), the instruction file 22 is created to provide step-by-step instructions to the transformation engine 16 on how to use each software code in the library 20 to modify the reference application 14, and the order for making the changes. For example, the instruction file 22 may include instructions, such as whether the software code should replace certain code in the reference application 14, or should merely be added to the existing code.

One embodiment of a XML instruction file 22 for the device plug-in 18a is provided below.

<class-actions>

<class-action orderId=“10” description=“replace the Canvas

repaint with tiraPaint implementation” dolt=“true”>

<action-

class>com.tira.coreserv.transformation.classactions.ReplaceMethodCallAction</action-class>

<arg

name=“oldClassName”>javax/microedition/lcdui/Canvas</arg>

<arg name=“oldMethodName”>repaint</arg>
<arg

name=“newClassName”>com/nokia/mid/ui/FullCanvas</arg>

<arg name=“newMethodName”>tiraRepaint</arg>

</class-action>
<class-action orderId=“20” description=“replace Canvas's

drawString method call with Tira's drawString” dolt=“true”>

<action-

class>com.tira.coreserv.transformation.classactions.ReplaceStaticAction</action-class>

<arg name= “oldClassName”>

javax/microedition/lcdui/Graphics</arg>

<arg name=“oldMethodName”>drawString</arg>
<arg

name=“newClassName”>com/tira/packaging/platform/TiraStaticMethods</arg>

<arg name=“newMethodName”>drawString</arg>

</class-action>
<!-- replaces a the paint method for double buffering-->
<class-action orderId=“90” description=“double buffer”

dolt=“true”>

<action-

class>com.tira.coreserv.transformation.classactions.ReplacePaintCallAction</action-class>

</class-action>
<!-- absorb paints
optional arguments:

interval - repaint interval

-->
<class-action orderId=“100” description=“paint absorbtion”

dolt=“true”>

<action-

class>com.tira.coreserv.transformation.classactions.PaintAbsorbtionAction</action-class>

<arg name=“interval”>100</arg>

</class-action>
<!-- resolve the key mapping-->
<class-action orderId=“110” description=“key mapping”

dolt=“true”>

<action-

class>com.tira.coreserv.transformation.classactions.KeyMappingAction</action-class>

</class-action>
<!--
<class-action orderId=“60” description=“flipImage”

dolt=“true”>

<action-

class>com.tira.coreserv.transformation.classactions.FlipImageAction</action-class>

</class-action>

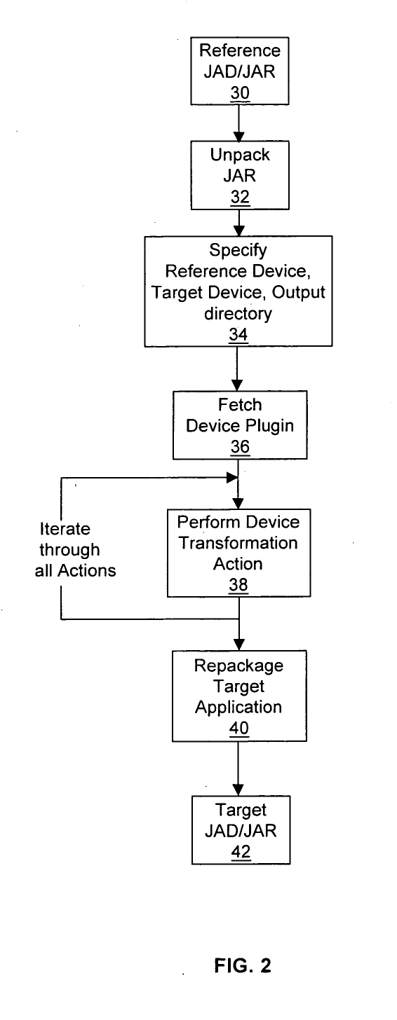

The operation of the first embodiment of the present invention will now be described with reference to FIGS. 1 and 2.

The operation begins at step 30, where the reference application 14 (written to execute on the reference device), perferably packaged in a JAD/JAR pair is loaded into the memory of the personal computer.

The process then moves to step 32, where the JAR file of the reference application 14 is unpacked by the transformation engine 16 into bytecode consisting of class files. The class file is a precisely defined file format to which Java programs are compiled. The class file may be loaded by any JVM implementation. The Java class file contains all components required by the JVM in order for the application to run. The class file contains the following major components: constant pool, access flags, super class, interfaces, fields, methods, and attributes. The order of class file components is strictly defined so that JVMs are able to correctly identify and execute the various components of the class file.

At step 34, the identities of reference mobile device and the chosen target mobile are input into the transformation engine 16. In addition, an output directory for the target application 12 is input into the system 10. If generation of multiple target applications 12a, 12b, 12c for different target mobile devices is desired, the list of target devices is also input into the system 10.

At step 36, the transformation engine 16 selects one of the device plug-ins 18a, 18b, 18c which corresponds to the inputted combination of reference and target mobile device. For example, if the selected reference mobile device is the Nokia™ Series 40 wireless phone and the target mobile device is the Samsung™ S300 wireless phone, device plug-in 18a is selected.

The operation then moves to step 38, where the transformation engine instructs the computer to perform the transformation.

Where the target mobile device supports Java, the transformation engine 16 performs the transformation step by carrying out the first instruction in the instruction file 22 of the device plug-in 18a. If such instruction requires modifying a particular element of a class file, the transformation engine 16 scans the class files of the reference application 14 and locates the relevant class file. The transformation engine 16 may then modify the relevant class file with a selected software code 24. Specifically, the instruction file 22 instructs the transformation engine 16 to copy the selected software code 24 from the library 20 of the device plug-in 18a and to insert it into the appropriate place in the relevant class file.

Examples of different types of modifications which may be performed by the transformation engine 16 are set out below:
1. Add a new method to a class file, as follows:
   a. insert the new method info in the class file method list;
   b. insert the method name and type in the class file constant pool;
   c. insert the body of the source method in the class file;
   d. adjust the newly inserted method body with the class file context (validate brach instruction targets and instruction length).
2. Rename an existing method in a class file, as follows:
   a. find the method definition in the constant pool; and
   b. rename the method's name entry in the constant pool.
3. Replace the method call of a particular object [e.g. “o1.method1(arg1, arg2 . . . argn)”] with a method call of another object in a class file [e.g. “o2.method2(arg1, arg2 . . . argn)”], as follows:
   a. search all the references of the o1.method1 call in the class file; and
   b. — replace the references with o2.method2.
4. Replace an original method call [e.g. “o1.method1(arg1, arg2 . . . argn)”] with a static method call [e.g. “static o2.method2(o1, arg1, arg2 . . . argn)”] in a class file, as follows:
   a. search all the references of the o1.method1 call in the class file; and
   b. replace the references with o2.method2.
5. Rename constant pool entries in a class file, as follows:
   a. search for the constant pool entry; and
   b. rename it.
6. Insert a new class file, as follows:
   a. add the reference of the inner class to the target class file; and
   b. copy the compiled inner class to the target class file.

Specific examples of different types of transformations which may be carried out by the system 10 are provided below.

### EXAMPLE 1

### API Functional Differences

This transformation relates to the implementation of the method drawRoundRect of the javax.microedition.lcdui. Graphics class on a Samsung™ S300 target mobile device. This implementation deviates from the reference mobile device (Nokia™ Series 40), which follows the MIDP (Mobile Information Device Profile) specification from the J2ME family.

The purpose of the above method is to draw the outline of a rounded corner rectangle at specified coordinates with the specified width, height, arc width and arc height. However, on the Samsung™ S300 device, the rounded corners are not rendered in the desired manner on the screen. As a result, the reference application 14, which runs on the reference mobile device (in this example, Nokia™ Series 40) and uses the drawRoundRect method, will not run in the desired manner on the Samsung™ S300 target mobile device.

To address this issue, the method call to the drawRoundRect method is replaced by modifying the class file(s) in which the method being called is defined. This is accomplished by multiple iterations of the transformation action 38, as described below.

First, a new class file (for a new class called Replacement) is added to the reference application 14. The new class file contains a static method, which has the same method signature as the method being replaced except that a parameter is added to the beginning of the list of parameters. The newly added parameter is of the same type as the “this” object of the method being replaced.

For greater clarity, an excerpt of the Graphics class that contains the drawRoundRect method is provided below.

package javax.microedition.lcdui;
package javax.microedition.lcdui;
public Class Graphics
{

| . | |
|---|---|
| . | |
| . | |
| public void drawRoundRect( | int x, |

int y,
int width,
int height,
int arcWidth,
int arcHeight)

.
.
.

}

As discussed above, a new class called Replacement is added. An excerpt of the Replacement class is provided below.

import javax.microedition.lcdui.Graphics;
public Class Replacement
{

.
.
.
static public void newDrawRoundRect(Graphics g,

int x,
int y,
int width,
int height,
int arcWidth,
int arcHeight)

.
.
.

}

Second, the method calls to the original method are replaced by calls to the static method. In the above example, the method calls to Graphics.drawRoundRect are replaced by call to Replacement.newDrawRoundRect. In most object-oriented languages, such as Java, the “this” pointer is passed as an implicit argument to every member method. Typically, “this” is passed in as the first argument of any member method. Therefore, changing the method call merely requires renaming the class type and the method name. The parameter stack does not require alteration in this particular example.

### EXAMPLE 2

### Different Device API's

Another example of a transformation action provided in device plug-in 18b (i.e. where the reference mobile device is the same, and the target mobile device is a Motorola™ wireless telephone) is provided below. In this example, the reference application 14 utilizes the Nokia™ Sound API (com.nokia.sound.Sound class) for playing sound files, while the target device is a Motorola™ device which has its own proprietary API (com.motorola.midi.MidiPlayer class) for playing sound files. To redirect the method call, a class with the same name as the Nokia™ Sound API (com.nokia.sound.Sound class) is added to the class files. The method calls are then remapped to the appropriate method calls in the com.motorola.midi.MidiPlayer class.

### EXAMPLE 3

### API Performance Differences

In the MIDP implementation of a Samsung™ S300 mobile phone, the speed of execution of the drawArc method of the javax.microedition.lcdui.Graphics class was determined to be significantly slower than when running on the reference mobile device (Nokia™ Series 40).

The function of the drawArc method is to draw the outline of a circular or elliptical arc covering a specified rectangle. The screen redraw frame rate of the reference application 14 which uses the drawArc method will provide a poor user experience (particularly if the reference application is a game) when running on the Samsung™ S300 mobile phone (the target device for this example).

In order to improve performance, the method call to the drawArc method may be replaced by modifying the class file(s) in which the method being called is defined, and creating a new class file (for a new class called Replacement) which contains a static method called newDrawArc. The static method has the same method signature as the method being replaced, except for a parameter which is added to the beginning of the list of parameters. The newly added parameter is of the same type as the “this” object of the method being replaced.

An excerpt of the Graphics class that contains the drawArc method is set out below.

package javax.microedition.lcdui;
public Class Graphics
{

| . | |
|---|---|
| . | |
| . | |
| public void drawArc( | int x, |

int y,
int width,
int height,
int startAngle,
int arcAngle)

.
.
.

}

A new class called Replacement is added to the target application 12a. An excerpt of the Replacement class is set out below.

public Class Replacement
{

| . | |
|---|---|
| . | |
| . | |
| static public void newDrawArc( | Graphics g, |

int x,
int y,
int width,
int height,
int startAngle,
int arcAngle)

.
.
.

}

The method calls to the drawArc method are replaced by calls to the static method in the target application 12a. In the above example, the method calls to Graphics.drawArc are replaced by calls to Replacement.newDrawArc. In most object-oriented languages, such as Java or C++, the “this” pointer is passed as an implicit argument to every member method. Typically, “this” is passed in as the first argument of any member method. Therefore, changing the method call merely requires renaming the class type and the method name. The parameter stack does not need to be altered.

### EXAMPLE 4

### Device Key Event Handler Differences

This example relates to an alternative embodiment of the present invention where the Nokia™ 7650 mobile phone is the reference mobile device, and the Nokia™ 3650 mobile phone is the target mobile device.

The keypad layouts of the Nokia™ 7650 and 3650 mobile phones are very different. The 7650 phone has a conventional numeric keypad and the 3650 phone has a circular, counter-clockwise numeric keypad. In this embodiment, the reference application 14 is a game written to run on the 7650 phone. The reference application may run on the 3650 phone, but it is desirable to reassign the keys for different functions from a usability perspective. For example, a game running on the Nokia™ 7650 may use the ‘1’, ‘3’, ‘7’ and ‘9’ keys to navigate in the 4 diagonal directions while it is desirable to use the ‘1’, ‘0’, ‘4’ and ‘7’ keys to navigate in the same directions on the Nokia™ 3650.

For key input in MIDP applications, the Canvas class provides three callback methods: keyPressed( ), keyReleased( ), and keyRepeated( ). KeyPressed( ) is called when a key is pressed, keyRepeated( ) is called when the user hold down the key for a longer period of time, and keyReleased( ) is called when the user releases the key.

All three callback methods provide an integer parameter, denoting the Unicode character code assigned to the corresponding key. The Unicode character code is a unique number assigned to each character in accordance with the Unicode Standard, which has been developed by the Unicode Consortium. If a key has no Unicode correspondence, the given integer is negative. MIDP defines the following constant for the keys of a standard ITU-T keypad: KEY_NUM0, KEY_NUM1, KEY_NUM2, KEY_NUM3, KEY_NUM4, KEY_NUM5, KEY_NUM6, KEY_NUM7, KEY_NUM8, KEY_NUM9, KEY_POUND, and KEY_STAR. Some keys may have an additional meaning in games. For this purpose, MIDP provides the constants UP, DOWN, LEFT, RIGHT, FIRE, GAME_A, GAME_B, GAME_C, and GAME_D. The “game” meaning of a key press can be determined by calling the getGameAction( ) method. The mapping from key codes to game actions is device dependent. Consequently, different keys may map to the same game action on different devices. For example, some devices may have separate cursor keys; others may map the number keypad to four-way movement. Also, several keys may be mapped to the same game code. The game code can be translated back to a key code using the getKeyCode( ) method. This also offers a way to get the name of the key assigned to a game action.

Even though MIDP has a device independent way of mapping “game” keys using the UP, DOWN etc. constants, this capability usually only suffices for simple applications and games. For example, any application that requires diagonal navigation will find the “game” constants insufficient. Also, because of the large variety of applications, a single set of key mapping might not be optimized for all applications.

In order to transform the reference application 14 into the target application 12, software codes 24 are inserted into the reference application in order to intercept the key events. First, the keyPressed method is renamed to originalKeyPressed. Second, a keyPressed method is written and inserted into the reference application. The keyPressed method calls the originalKeyPressed method. In this manner, an interception module is created in the reference application which intercepts all key events.

After the reference application is modified with the interception module, a device-specific conversion table is inserted into the interception module. The conversion table defines the key mapping between the reference mobile device (7650 phone) and the target mobile device (3650 phone). The four diagonal direction keys are remapped as follows:

| Nokia | 7650 ITU-T Key | Nokia | 3650 ITU-T Key |
|---|---|---|---|
| 7650 Key | code | 3650 Key | code |
| 1 | 49 | 1 | 49 |
| 3 | 51 | 0 | 48 |
| 7 | 55 | 4 | 52 |
| 9 | 57 | 7 | 55 |

An interception module is also provided for The KeyReleased( ) and keyRepeated( ) in the same manner as described above. In this manner, the reference application 14 is transformed into the target application 12.

When a particular key is pressed (and similarly for when a key is released or a key is repeatedly pressed) on the target mobile device (3650 phone), it sends the key code corresponding to the pressed key to the target application through the keyPressed method. The interception module modifies the value of the key code according to the table and then sends the modified key code back to the target application.

For example, when the ‘7’ key is pressed on the 3650 phone, the device generates a key code with a value equal to 55 and calls the method keyPressed with this value. The value is then modified to 57 and passed back to the application by calling the method originalKeyPressed.

Similarly, the getGameAction method and the getKeyMode method may be overridden in the same manner. Also, for non-MIDP applications, such as applications written for the Personal Profile, similar method calls with different names can be found.

### EXAMPLE 5

### Device Graphic Limitations

In this example, the reference mobile device is again the Nokia™ Series 40 mobile phone, and the target device is the Sony™ Ericsson™ T610 mobile phone.

Application graphics (such as those used in game applications) often consist of multiple layers. For example, the background scenery may be one layer. A structure, such as a road, appearing on the screen may be another layer. A vehicle traveling on the road may be a third layer. Layers may also be used to create motion, commonly referred to as a sprite. In general, a sprite is defined as a layer that contains several frames stored in an image. One image may contain several frames, where each of the frames depicts a particular character, such as a dog, in different positions. Displaying frames in a particular sequence and at a specific frame rate therefore creates motion, such as the effect of a walking dog.

If a game application for a mobile device requires animation, it may not execute at all or may not provide a satisfactory user experience (by executing slowly) on certain mobile devices due to the size of the images required to produce the animation or image limitations (such as height or width). Certain reference applications, such as games, that use large images may execute normally on the reference mobile device. However, the same reference applications may execute too slowly to provide a satisfactory user experience on certain target mobile devices. Moreover, if the width or height of the image in the reference application is greater than some threshold, the reference application may crash when running on a particular target mobile device. Therefore, the transformation of the reference application to the target application may require manipulation of the graphic images in the reference application.

In MIDP 1.0, the Image class and the Graphics class are primarily responsible for loading and displaying images. The Image class is used to temporarily store graphical image data for further usage. Image objects are stored in off-screen memory, independently of the device's display, and will not be painted on the display unless an explicit command is issued by the application (such as within the paint( ) method of the Canvas class in MIDP). Images are either mutable or immutable depending on how they are created. Immutable images are generally created by loading image data from resource bundles, from files, or from a network. They may not be modified once created. Typically, there are limitations on certain target devices relating to immutable images and so this example relates to an issue dealing with immutable images only.

As discussed above, parts of an immutable image may be divided up into frames and a sequence of frames can be used to create motion or animation. To display a sprite, the clipping area is set to the size of the frame to be displayed. As graphics rendering operations have no effect outside of the clipping area, only the frame that is supposed to be displayed will be visible. As a result, in most cases, only a portion of the immutable image will be displayed at any given time. Since only a portion of the image is displayed at any point in time, manipulating the graphic images (e.g. making the images smaller) does not impact the game play.

In this example, an additional modification of the reference application 14 may be performed prior to performing the transformation actions of step 38. This additional modification is the breaking down of the immutable image into smaller images, and is performed after step 32. This modification is preferably performed for specific target devices if the immutable image size exceeds a predetermined threshold, such as image height, image width, or both. If performed, the immutable image is broken down into smaller images, each of which is referred to as a grid. The grid sizes are not required to be identical. The only criteria are that the image height of each row of images are substantially identical and the image width of each column of images are substantially identical. If the smaller image is used as a sprite, the sprite is organized in such a way so as to minimize the amount of wasted space in the graphics file. The smaller images will use the following naming convention: XRC.png, where X is the name of the original file, R is the zero-based row number, and C is the zero-based column number.

Several iterations of the transformation action 38 are performed for this transformation. As for the above examples, a new class file (for a new class called Replacement) is added to the reference application 14. The new Replacement class contains static methods newCreateImage and newDrawImage. These static methods have the same method signatures as the corresponding method which they replace, but a parameter is added to the beginning of the list of parameters if the original method is not static method. The newly added parameter is of the same type as the “this” object of the method to be replaced.

Excerpts from the Image and Graphics class, respectively, are set out below.

package javax.microedition.lcdui;
public Class Image
{

| . | |
|---|---|
| . | |
| . | |
| static public Image createImage(String path) | |
| public void getWidth( ) | // explained below |
| public void getHeight( ) | // explained below |
| . | |
| . | |
| . | |

}

and

package javax.microedition.lcdui;
public Class Graphics
{

.
.
.

public void drawImage(Image img, int x, int y, int anchor)

.
.
.

}

An excerpt of the Replacement class is provided below.

import javax.microedition.lcdui.Graphics;
public Class Replacement
{

.
.
.
static public void newCreateImage(String path)
static public void newDrawImage(Graphics g, Image img, int x, int y,
int anchor)
.
.
.

}

As for the other examples discussed above, the method calls to the original methods are replaced by method calls to the static methods. Specifically, method calls to Image.createImage and Graphics.drawImage are replaced with method calls to Replacement.newCreateImage and Replacement.newDrawImage, respectively.

The above transformation provides the original application developers with the advantage of abstracting the handling of immutable images. It does so by breaking the immutable image into a grid of smaller images as discussed above. When the immutable image is to be displayed, the Graphics.drawImage repaints only those portions of the grid required to update the image.

### EXAMPLE 6

### Device Processing Limitations

In this example, the reference mobile device is the Nokia™ Series 40 mobile phone, and the target device is the Samsung™ S105 mobile phone.

In the MIDP implementation of a Samsung™ S105 mobile phone, if the screen refresh or repaint frame rate is greater than 4-6 frames per second, most of the processing capability of the device will be used for screen repaints. Accordingly, the target device will not have sufficient processing capability to execute the remaining functionality of the reference application 14 to provide a satisfactory user experience. In order to improve performance, the method paint, which is called by the Java K Virtual Machine (a version of the JVM for mobile computing devices with limited memory) when a repaint is requested, is replaced by a method used to absorb excessive repaints to the screen. This is performed by renaming the method name to originalPaint and inserting a new method called paint to the class file(s) in which the method paint is originally defined. For example, the MyCanvas class is modified as follows:

public class MyCanvas extends Canvas
{
.
.
.
public void paint(Graphics g)
{

// draw objects to the display

}
}
to become
public class MyCanvas extends Canvas
{
.
.
.
public void paint(Graphics g)
{

if(currentTime − lastRepaintTime) >= X)
// (i.e. last repaint more than
X millisecond ago)
{

lastRepaintTime = currentTime;
originalPaint(g);

}

}
public void originalPaint(Graphics g)
{

// draw objects to the display

}
}

### EXAMPLE 7

### Graphics Scaling

This example is directed to transforming a reference application (such as game) developed for a reference mobile device having one screen size to a target application which runs on a target mobile device having a different screen size. As used herein, “different screen size” means the length and/or width of the device screen has a different dimension measured in number of pixels.

Typically, J2ME applications draw to the screen by making calls to the Graphics interface. This interface provides methods for drawing images, text, and shapes. This transformation scales the parameters to these calls so that they appear in the same place on the screen on each device.

The Graphics interface is passed to the application's paint method. An example of a simple J2ME Canvas print method is described below.

protected void paint(Graphics graphics)
{

| // draw the background | | |
|---|---|---|
| graphics.setColor(0, 0, 255); | | |
| graphics.fillRect(0, 0, getwidth( ), getHeight( )); | | |
| // draw the score string | | |
| graphics.drawString(strScore, 0, 5, | | |
| Graphics.TOP\|Graphics.LEFT); | | |
| // draw the player image | | |
| graphics.drawImage(imgPlayer, | playerX, | playerY, |

Graphics.TOP|Graphics.LEFT);
}

This transformation replaces all the Graphics calls by calls to the Graphics Scaler method. The paint method becomes the following:

protected void paint(Graphics graphics)
{

| // draw the background | | |
|---|---|---|
| GraphicsScaler.setColor(graphics, 0, 0, 255); | | |
| GraphicsScaler.fillRect(graphics, 0, 0, | | |
| getwidth( ), getHeight( )); | | |
| // draw the score string | | |
| GraphicsScaler.drawstring(graphics, | | |
| strScore, | 0 , | 5 , |

Graphics.TOP|Graphics.LEFT);

// draw the player image
GraphicsScaler.drawImage(graphics,
imgPlayer, playerX, playerY,

Graphics.TOP|Graphics.LEFT);
}
An example of the Graphics Scaler method is
described below.
public static void drawImage(Graphics g,
Image image, int x, int y, int anchor)
{

g.drawImage(image, x * toWidth /
fromWidth, y * toHeight / fromHeight,

anchor);
}

Floating point operations are not supported in older versions of J2ME. In such versions, the parameters must be multiplied by the target device width and height, then divided by the width and height of the reference device. The fromWidth and fromHeight variables are set to the width and height of the reference device. toWidth and toHeight are queried from the target mobile device at run-time.

Referring again to FIGS. 1 and 2, transformation action 38 is then repeated as required until the transformation engine 16 completes all of the actions in the instruction file 22. After the completion of the steps in the instruction file 22, the transformation engine 16 has transformed the class files of the reference application 14 into the appropriate bytecode for the target application 12a.

The operation then moves to a step 40, where the target application 12a is repackaged into executable code for the target application 12a, as described below.

In the present embodiment, where the target application 12a is a Java application, step 40 may include obfuscating the class files of the target application 12a. The obfuscation is performed in order to reduce the resulting target JAR and to remove any unused fields and methods.

Step 40 may also include pre-verification of the class files of the target application 12a. The pre-verification adds supplementary information to the bytecode (such as the stack map attributes), which is used by the JVM, and is also used to validate the bytecode prior to run-time. The bytecode for the target applications 12a is then packaged into a JAR file and the corresponding JAD file is modified in accordance with the changes at step 42.

The target application 12a generated by the system 10 may require some additional manual modification to optimize its performance on the target mobile device.

A different target application 12b or 12c may be created from the reference application 14, by returning to step 34 and selecting device plug-in 18b or 18c respectively. The above process may then be repeated to generate the target applications 12b or 12c.

Alternatively, a different reference application may be selected for transformation for the same reference mobile device/target mobile device combination. In this case, the process must be repeated for the second reference application starting with step 30. In this manner, many different reference applications may be transformed into corresponding target applications for a particular combination of a reference and target mobile device using a single device plug-in (such as device plug-in 18a for the Nokia™ Series 40/Samsung™ S300 wireless telephone combination).

In the above example, the device plug-in 18a may be used to automatically transform a variety of different reference applications (such as different games) which run on the Nokia™ Series 40 phones into corresponding target applications for the Samsung™ S300 phones. This provides the advantage of allowing developers to reduce development time by only having to write an application for a single reference device. The present invention automates the process of migrating the application to target devices which may not otherwise support the reference application, thereby greatly reducing the development time required to migrate the applications, as well as reducing the time and expense required to manage and maintain multiple versions of source code.

In addition, the present invention provides an advantage over the prior art on-line interpretation method by eliminating the need to run the transformation process on the target mobile device, which may not have the performance characteristics for such a task.

Alternatively, where the target mobile device does not support Java, the class files of the reference application 14 are translated into the source code of a language target mobile device. One example of such a language may be C++, which is supported by target mobile devices using the BREW™ or Symbian™ platforms. As the standard Java libraries, such as the MIDP classes, are utilized within the reference application 14, an empty implementation, usually called a “stub” implementation is also supplied to the code translator in order to generate the source code. Once the source code is generated, the code that corresponds to the stub implementation is then replaced with an implementation that maps to the method calls in the native libraries for the target device. The source code is then recompiled and packaged into an executable in the native format of the target device.

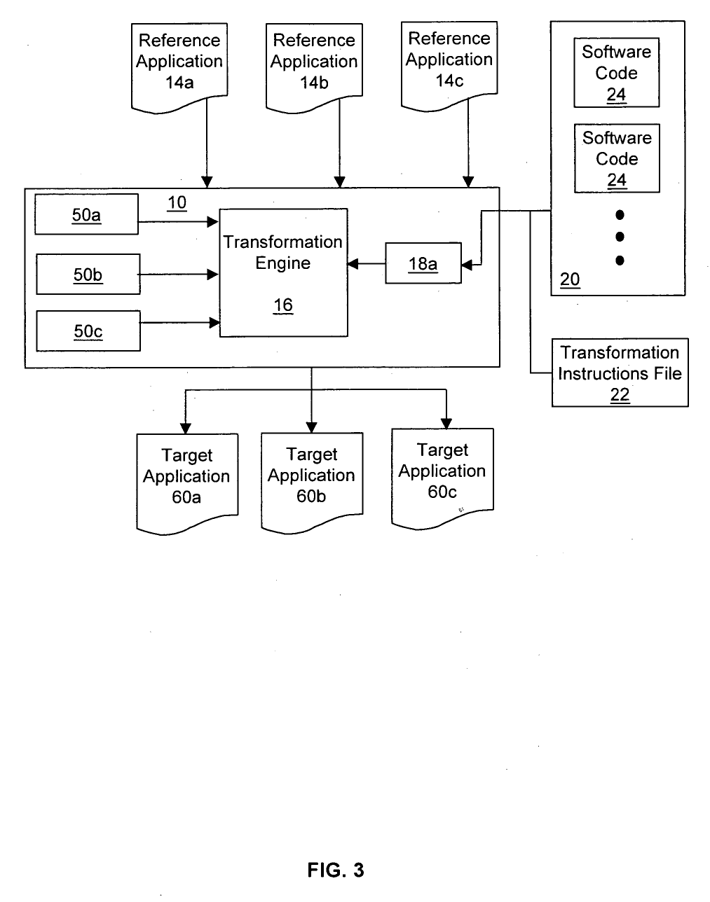

FIG. 3 shows a system according to a second embodiment of the present invention which is capable of further optimizing the performance of the target applications. Parts corresponding to those in the first embodiment have been assigned like reference numbers and will not be further described.

Referring to FIG. 3, three different reference applications 14a, 14b, and 14c are shown. Also, three application plug-ins 50a, 50b, and 50c are shown. Each application plug-in 50a-c is configured for transforming a corresponding reference application 14a-c into a corresponding target application 60a-c. In this manner, an application plug-in is created for each reference application to be transformed from a reference mobile device to a target mobile device. In other words, if one reference application was to be transformed for two different target mobile devices, typically, two application plug-ins would be developed.

Preferably, the application plug-ins 50a-c are written in Java code, although any other suitable method of providing instructions (such as a structure similar to that described for the device plug-in 18a) may be used. Although, for clarity, only one device plug-in 18a, and three application plug-ins 50a-c are shown in FIG. 3, it will be understood by those skilled in the art that this embodiment could include any suitable number of device and application plug-ins depending on the number of reference applications to be transformed and the number of mobile device combinations.

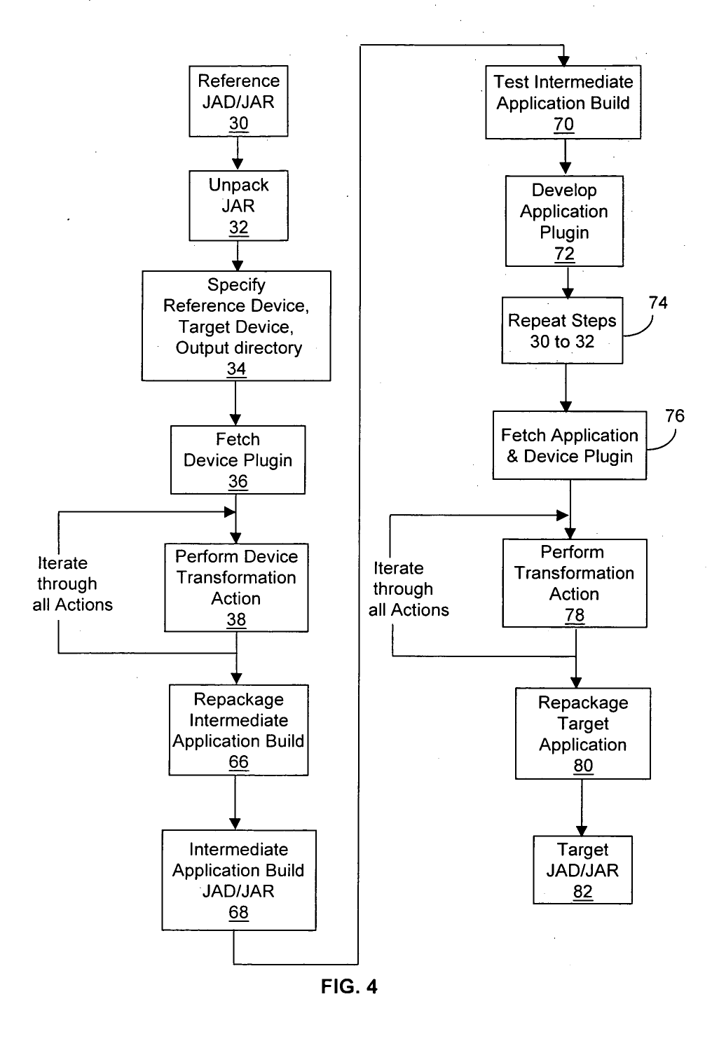

FIG. 4 shows the operation of the second embodiment of the present invention. The operation begins with applying steps 30-38 to one of the reference applications 14a. These steps are identical to those described for the first embodiments and will not be described again. These steps result in a transformed application, which will be referred to as an intermediate application build for the purposed of describing this embodiment.

The operation moves to step 66, where the intermediate application build produced by the device transformation step 38 is repackaged into executable code. Step 66 may also include obfuscating and pre-verification of the class files of the intermediate application build.

At step 68, the bytecode for the intermediate application build is then packaged into a JAR file, and the corresponding JAD file is modified in accordance with the changes.

At step 70, the intermediate application build is tested on the target mobile device or an emulator for the device for application-specific issues not addressed during transformation by the device plug-in 18a. Typical examples of application-specific issues are subjective/aesthetic issues, such as graphics or text appearing slightly out of alignment (thereby making an application, such as a game, less appealing).

At step 72, the application plug-in 50a for a particular reference application is developed, as described in more detail below.

The operation then moves to step 74, where steps 30-32 are duplicated to once again prepare the reference application 14a for transformation this time by both the device plug-in 18a and the application plug-in 50a.

At step 76, the transformation engine 16 loads both the application plug-in 50a and the device plug-in 18a for a particular reference application 14a and a particular reference/target mobile device combination.

The operation then moves to step 78, where the transformation actions stored in the device plug-in 18a and the application plug-in 50a are performed by the transformation engine 16 to produce the target application 60a. The transformation actions may be performed in any order. Specifically, the application plug-in transformations may be performed followed by the device plug-in transformations, or vice versa. Alternatively, one or more of device plug-in transformations may be performed followed by one or more of the application plug-in transformations until all transformations are completed. A detailed example of an issue addressed by the application plug-in is described below.

If the reference application is coded to draw a text string at grid coordinates (100, 100) for a reference mobile device with display size of 120×120 pixels (in other words, the text string looks best when it appears at 20 pixels to the left and 20 pixels above the bottom right corner of the display), such a text string may not appear at an aesthetically acceptable position on a target mobile device having a display size of 140×200 pixels when transformed solely by the device plug-in 18a (although the application may execute properly in all other respects).

A relevant excerpt of the source code for the reference application is show below:

package javax.microedition.lcdui.*;
public Class MyCanvas extends Canvas
{
.
.
.
public void paint(Graphics g)
{

g.drawString(“this one works”, 0, 0, g.TOP | g.LEFT);
g.drawString(“this one does not”, 100, 100, g.TOP | g.LEFT);

}
.
.
.

}

In order to correct this issue, the 2^{nd} parameter and the 3^{rd} parameter above is changed to 120 and 180 respectively. One embodiment of a Java instruction file for the application plug-in 50a which corrects this issue is provided below:

public void adjust(IAdjustment adj)
{

IMethodCallPointcut mcpc =
adj.getMethodCallPointcut(“MyCanvas”, “paint”,

“drawString”, 2);

mcpc.modifyParameter(2, 120);
mcpc.modifyParameter(3, 180);

}

In the above example, the variable “adj” is a handle to the application code. Calling getMethodCallPointcut through this variable will return a handle to the method call (the 2nd drawString in the original application) that requires changes. Changes can then be applied by calling modifyParameter.

Additional examples of different types of transformations which the application plug-in may instruct the transformation engine to perform are set out below.
1. Modify a method call, as follows:
   a. insert code before the method call;
   b. insert code after the method call;
   c. replace the method call (includes removing the entire method call);
   d. modify the parameters of the method call; and
   e. modify the return value of the method call.
2. Modify a method/constructor, as follows:
   a. insert code at the beginning of the method/constructor;
   b. insert code at the end of the method/constructor;
   c. modify the method/constructor body;
   d. add a try/catch block of the entire method/constructor body; and
   e. rename the method (not applicable to constructor).
3. Modify a “new” expression, as follows:
   a. insert code before the “new” call;
   b. insert code after the “new” call;
   c. replace the “new” call;
   d. modify the parameters of the “new” call; and
   e. modify the return value of the “new” call.
4. Modify an exception handler, as follows:
   a. insert before an exception handler.
5. Modify a field access, as follows:
   a. insert code before the field access;
   b. insert code after the field access;
   c. replace the field access (including removing the entire field access); and
   d. modify the return value of the field access.

While the present invention as herein shown and described in detail is fully capable of attaining the above-described objects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more. ” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims.

1. A method of generating a target application configured for a target mobile device from a Java reference application configured to execute on a reference mobile device, the method comprising:
a) unpacking the reference application into a plurality of class files;
b) transforming the reference application into the target application by a device plug-in, wherein the device plug-in is adapted to transform a plurality of different reference applications into a corresponding plurality of target applications for a predetermined combination of the reference mobile device and the target mobile device.

2. The method of claim 1, wherein the reference application is in bytecode during the transformation step.

3. The method of claim 2, wherein the device plug-in comprises an instruction file and at least one library, wherein the transformation step comprises the instruction file instructing a transformation engine to modify a portion of the reference application with a selected software code stored in the library, wherein the portion of the reference application is not supported by the target mobile device.

4. The method of claim 3, wherein the transforming step comprises modifying at least one of a plurality of class files in the reference application.

5. The method of claim 4, wherein the transformation step comprises adding a new class file to the reference application.

6. The method of claim 4, wherein the modifying step comprises at least one action selected from the group of: adding a new method, renaming an existing method, replacing a first object method call with a second object method call, replacing the first object method call with a static method call, renaming a constant pool entry, and inserting a new inner class to an existing class.

7. The method of claim 6, further comprising saving the target application to a computer readable medium.

8. The method of claim 7, further comprising repeating step (a) and step (b) to transform the plurality of different reference applications into the plurality of corresponding target applications.

9. The method of claim 1, further comprising selecting a predetermined device plug-in from a plurality of the device plug-ins, the predetermined device plug-in corresponding to the predetermined combination of the reference mobile device and the target mobile device, each of the plurality of the device plug-ins corresponding to a different combination of the reference mobile device and the target mobile device.

10. The method of claim 3, further comprising repackaging the target application into executable code.

11. The method of claim 10, wherein the repackaging step further comprises obfuscating the class files of the target application.

12. The method of claim 10, wherein the repackaging step further comprises pre-verifying the class files of the target application.

13. The method of claim 3, wherein the target application is a non-Java application.

14. The method of claim 6, wherein the unpacking step comprises unpacking a JAR file of the reference application.

15. The method of claim 14, wherein the method further comprises breaking an immutable image from the reference application into a plurality of smaller images.

16. The method of claim 2, wherein the transformation step comprises inserting an interception module into the reference application, wherein the interception module is adapted to intercept key events.

17. The method of claim 16, wherein the transformation step comprises inserting a conversion table into the interception module, wherein the conversion table defines key-mapping from the reference mobile device to the target mobile device.

18. A method of generating a target application configured to execute on a target mobile device from a Java reference application configured to execute on a reference mobile device, the method comprising:
a) unpacking the reference application into a plurality of class files; and
b) transforming the reference application into the target application by a device plug-in and an application plug-in, wherein the device plug-in is adapted to transform a plurality of different reference applications into a corresponding plurality of target applications for a predetermined combination of the reference mobile device and the target mobile device, wherein the application plug-in is adapted to modify a portion of the reference application, wherein the portion does not execute optimally on the target mobile device after transformation of the reference application by the device plug-in.

19. The method of claim 18, wherein the transformation step further comprises:
i) transforming the reference application into an intermediary application build by the application plug-in; and
ii) transforming the intermediary application build into the target application by the device plug-in.

20. The method of claim 19, wherein step (i) further comprises the application plug-in instructing the transformation engine to modify the portion of the reference application.

21. The method of claim 20, wherein the reference application is in bytecode during the transformation step.

22. The method of claim 21, wherein the application plug-in comprises Java code.

23. A method of generating a target application configured to execute on a target mobile device from a Java reference application configured to execute on a reference mobile device, the method comprising:
a) unpacking the reference application into a pluarality of class files;
b) transforming the reference application into an intermediary application build by a device plug-in;
c) generating an application plug-in adapted to modify a portion of the reference application, wherein the portion does not execute optimally on the target mobile device after transformation of the reference application by the device plug-in;
d) repeating step (a); and
e) transforming the reference application into the target application by the device plug-in and the application plug-in.

24. The method of claim 23, wherein step (e) further comprises:
i) transforming the reference application into the intermediary application build by the application plug-in; and
ii) transforming the intermediary application build into the target application by the device plug-in.

25. A system for transforming Java reference applications adapted to execute on a reference mobile device into corresponding target applications configured for a target mobile device, the system comprising:
a) a transformation engine; and
b) a device plug-in comprising:
i) an instruction file; and
ii) a selected software code adapted to modify a portion of the reference application not supported by the target mobile device;
wherein the transformation engine is adapted to access the instruction file, the instruction file being adapted to direct the transformation engine to identify the portion of the reference application and to modify the portion with the selected software code.

26. The system of claim 25, wherein the instruction file comprises an XML file.

27. The system of claim 26, wherein the device plug-in comprises a library, the library being adapted to store a plurality of the software codes adapted to modify a plurality of the portions.

28. The system of claim 27, wherein the transformation engine is a Java application.

29. The system of claim 26, wherein the selected software code comprises an interception module adapted to intercept key events.

30. The system of claim 29, wherein the interception module comprises a conversion table adapted to define key-mapping from the reference mobile device to the target mobile device.

31. The system of claim 26, wherein the selected software code comprises a new method adapted for insertion into the reference application.

32. The system of claim 26, wherein the selected software code comprises a static method call adapted for insertion into the reference application.

33. The system of claim 26, wherein the selected software code comprises a new method name adapted to replace a method name in the reference application.

34. The system of claim 26, wherein the selected software code comprises a new object method call adapted to replace a method call in the reference application.

35. The system of claim 26, wherein the selected software code comprises a new class file adapted for insertion into the reference application.

36. The system of claim 26, further comprising a plurality of the device plug-ins, each of the plurality of the device plug-ins corresponding to a different combination of reference and target mobile device, wherein the transformation engine is adapted to choose a selected one of the device plug-ins corresponding to the different combination.

37. The system of claim 27, wherein the target applications are Java applications.

38. The system of claim 27, wherein the target applications are non-Java applications.

39. A system for transforming a Java reference application configured to execute on a reference mobile device into a target application configured to execute on a target mobile device, the system comprising:
a) a transformation engine; and
b) a device plug-in adapted to transform the reference application into a target application, the device plug-in comprising:
i) an instruction file; and
ii) a selected software code adapted to modify a portion of the reference application not supported by the target mobile device; and
c) an application plug-in adapted to instruct the transformation engine to modify at least a portion of the reference application;
wherein the portion of the reference application does not execute optimally on the target mobile device after transformation of the reference application by the device plug-in;
wherein the transformation engine is adapted to access the instruction file, the instruction file being adapted to direct the transformation engine to identify the portion of the reference application and to modify the portion with the selected software code.
